(19) United States
(12) Patent Application Publication
(10) Pub. No.: US 2026/0236814 A1
(43) Pub. Date: Aug. 13, 2026

(54) QUANTUM READOUT AND CONTROL

(71) Applicant: FERMI FORWARD DISCOVERY GROUP, LLC, Chicago, IL (US)

(72) Inventors: Gustavo Cancelo, Batavia, IL (US); Kenneth R. Treptow, Hinckley, IL (US); Neal G. Wilcer, Downers Grove, IL (US); Christopher Stoughton, Sycamore, IL (US); Leandro Stefanazzi, Geneva, IL (US); Sho Uemura, Batavia, IL (US)

(21) Appl. No.: 19/089,374

(22) PCT Filed: Sep. 28, 2023
(86) PCT No.: PCT/US2023/075396

§ 371 Date: Mar. 25, 2025

Related U.S. Application Data
(60) Provisional application No. 63/411,011, filed on Sep. 28, 2022.

(51) Int. Cl. G06N 10/40

(52) U.S. Cl. CPC G06N 10/40

(57) ABSTRACT

An FRC module comprises an integrated RF/FPGA-based qubit control system that integrates analog bandwidth DACs/ADCs with a System on Chip including processors and a large FPGA. RF channels can be controlled by a single module with a high channel density and the channels can be re-programmed into any feedback configuration. The embodiments support FPGA-level optimal filtering, state discrimination and feedback for qubit control; and a clock-synchronized state machine for time-critical quantum algorithms such as gate optimization.

### CROSS REFERENCE TO RELATED PATENT APPLICATIONS

This patent application claims priority under 35 U.S.C. § 119(e) to, and the benefit of, U.S. provisional patent application 63/411,011 entitled “QUANTUM READOUT AND CONTROL”, which was filed on Sep. 28, 2022. U.S. Provisional Patent Application Ser. No. 63/411,011 is incorporated herein by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

The embodiments are generally related to the field of readout devices. Embodiments further relate to the field of quantum information science and detectors. Embodiments further relate to the field of quantum devices. Embodiments are further related to the field of quantum computing. Embodiments are also related to readout and control for qubits and detectors. Embodiments are further related to quantum processing units.

Quantum computing offers a new frontier in computing technology. Quantum computers may be capable of vastly increasing the computing power currently available using classic computers. Even supercomputers are unlikely to rival the speed and computing power of quantum computers.

A “qubit” is the quantum computing equivalent of a bit in a classical computer. A bit is a means of encoding information, either as a zero or a one. In quantum computing, the qubit represents a similar mechanism for encoding information. However, in the case of qubits the state can be a zero, one, or a linear combination of those states simultaneously. As a result of the superposition of states possible in a qubit, quantum computers are situated to address certain computing problems much faster than classical computers.

Quantum processors made of entangled quantum-bits (qubits) are predicted to outperform classical computers in problem domains such as decryption, communication, and analysis. One promising quantum processing unit is the superconducting qubit, whose Hamiltonian can be engineered to be protected from various noise sources. Recent advances in superconducting qubit stability have enabled qubit systems to scale up. For example, there currently exist 53-qubit devices with high-fidelity quantum gates. To quickly iterate the control path and optimize gates for large systems of superconducting qubits, direct hardware-level feedback is necessary.

As such, there is a need in the art for readout and control electronics for quantum processing, as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for an improved system and method for readouts of quantum devices.

It is another aspect of the disclosed embodiments to provide for improved readout and control of quantum computing devices.

The aforementioned aspects and other objectives and advantages can now be achieved as described herein. In an embodiment, a system for readout and control of quantum devices, comprises a first board comprising a field programmable gate array and a radio frequency and bias board. In an embodiment, the system for readout and control of quantum devices further comprises an analog-to-digital converter configured on the first board and a digital to analog converter configured on the first board. In an embodiment, the system for readout and control of quantum devices further comprises a memory configured on the first board. In an embodiment, the field programmable gate array further comprises a radio frequency system on chip. In an embodiment, the radio frequency system on chip further comprises a pulse generator. In an embodiment, the system for readout and control of quantum devices further comprises the radio frequency system on chip further comprises a program control, a timing control, and a readout control. In an embodiment, the system for readout and control of quantum devices further comprises a processing system, the processing system further comprising: an application processing unit and a real time processing unit. In an embodiment, the processing system further comprises a DDR controller. In an embodiment, the processing system further comprises a security module and a platform management unit. In an embodiment, the system for readout and control of quantum devices further comprises a system control. In an embodiment, the system for readout and control of quantum devices further comprises a microsequencer. In an embodiment, the microsequencer is configured for storing instructions and storing parameters comprising: timing, amplitude, and frequency information.

In another embodiment, a system for readout and control of quantum devices, comprises a first board comprising a field programmable gate array, an analog-to-digital converter, and a digital to analog converter, wherein the first board is time and phase synchronized to a reference frequency and a radio frequency and bias board connected to the first board with at least one high density connector, wherein the radio frequency and bias board is time and phase synchronized to the reference frequency. In an embodiment, the system for readout and control of quantum devices further comprises an external clock source for generating the reference frequency. In an embodiment, the external clock source comprises a rubidium clock source. In an embodiment, the system for readout and control of quantum devices further comprises a program control, a timing control, and a readout control. In an embodiment, the system for readout and control of quantum devices further comprises a processing system, the processing system further comprising: an application processing unit and a real time processing unit. In an embodiment, the system for readout and control of quantum devices further comprises a DDR controller, a security module, a platform management unit, and a system control. In an embodiment, the system for readout and control of quantum devices further comprises a microsequencer, wherein the microsequencer is configured for storing instructions and storing parameters comprising timing, amplitude, and frequency information.

In another embodiment, a qubit control system comprises at least one analog bandwidth DAC, at least one analog bandwidth ACS, and a system on chip board comprising: a plurality of ARM processors and a field programmable gate array, and a plurality of RF channels wherein all of the plurality of RF channels are controlled by a single control module.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1A illustrates a system for readout and control of quantum devices, in accordance with the disclosed embodiments;

FIG. 1B illustrates another system for readout and control of quantum devices, in accordance with the disclosed embodiments;

FIG. 2 illustrates a block diagram of an RFSOC, in accordance with the disclosed embodiments;

FIG. 3A illustrates a block diagram of a readout and control system, in accordance with the disclosed embodiments;

FIG. 3B illustrates a block diagram of system firmware, in accordance with the disclosed embodiments;

FIG. 4A illustrates a block diagram of a microsequencer, in accordance with the disclosed embodiments;

FIG. 4B illustrates a block diagram of an embodiment of a microsequencer, in accordance with the disclosed embodiments;

FIG. 5 illustrates a block diagram of a pulse generator, in accordance with the disclosed embodiments;

FIG. 6 illustrates a chart showing the spectrum of mixer Up conversion from IF to RF, in accordance with the disclosed embodiments;

FIG. 7 illustrates an exemplary timing diagram, in accordance with the disclosed embodiments;

FIG. 8 illustrates exemplary data, in accordance with the disclosed embodiments;

FIG. 9 illustrates Up conversion from IF to RF, in accordance with the disclosed embodiments;

FIG. 10 illustrates a block diagram of a DAC output, in accordance with the disclosed embodiments;

FIG. 11 illustrates a block diagram of an RF input, in accordance with the disclosed embodiments;

FIG. 12 depicts a block diagram of a computer system which is implemented in accordance with the disclosed embodiments;

FIG. 13 depicts a graphical representation of a network of data-processing devices in which aspects of the present embodiments may be implemented; and

FIG. 14 depicts a computer software system for directing the operation of the data-processing system depicted in FIG. 12, in accordance with an embodiment.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

The disclosed readout and control warm electronics (FRC) comprise a multi-input multi-output high performance electronic system designed readout and control associated with quantum information science and detectors.

Qubits need to be read out in order to characterize their properties, for performing active reset on the qubit, for correcting errors by means of ancilla qubits during quantum computation, and for numerous other reasons. In addition, qubits need to be controlled for characterization, for finding their optimal operation point, for performing basic operations such as Clifford and random bench-marking, to correct errors, and to establish entanglement between qubits. Controlling qubits means manipulating the architectural parameters of the qubit to steer or prepare the qubit for certain Hamiltonian dynamics.

However, controlling qubits affects the qubit dynamics, potentially increasing its decoherence due to dephasing. This is one of the reasons why qubits are in constant evolution. It is important to note that classical warm electronics should not make decoherence worse. Rather, the goal should be that decoherence and qubit lifetimes should not be affected by the warm electronics.

The same can be said about qubit readout. This is easier to achieve given that between the qubit and the warm readout there is a cryogenic low noise amplifier LNA (typically a Traveling wave parametric amplifier (TWPA) or high mobility electron transistor (HEMT)). However, the input readout noise of the warm electronics should be smaller than the noise out of the cryo LNA to avoid lowering the S/N ratio of the readout.

Superconducting qubits are typically placed inside a resonant cavity. The qubit is read out using a QND (quantum non demolition) technique in which the state of the qubit is projected on the RF cavity. Hence, qubit readout can be frequency multiplexed. Typically, a single RF output is used to provide the readout tone whose transfer power is measured by one of the RF inputs of the readout and control (FRC) electronics. If the other 7 outputs are used for control, the number of qubits that can be controlled (per FRC board) depends on the qubit architecture.

For certain quantum devices direct feedback can be achieved using a platform which integrates fast RF DACs and ADCs with a Field-Programmable Gate Array (FPGA) as disclosed herein. FPGA-based feedback can speed up data acquisition, inform state preparation and allow for careful study of quantum trajectories and decoherence. The disclosed embodiments can comprise FPGA-based control systems utilizing direct feedback. Besides enabling direct feedback, an integrated RF/FPGA-based control system offers significant improvements in overall signal quality. For example, one can operate the RF DACs in higher Nyquist zones to directly generate microwave tones, eliminating the need for analog IQ mixers which add instability and noise and require meticulous calibration.

In certain embodiments, the readout and control (FRC) module disclosed herein comprises an integrated RF/FPGA-based qubit control system that can integrate 4 GHZ analog bandwidth DACs/ADCs (8 each) with a system on chip containing multiple different ARM processors and a large FPGA. In certain embodiments, sixteen RF channels can be controlled by a single module; there is a high channel density, and the channels can be re-programmed into any feedback configuration.

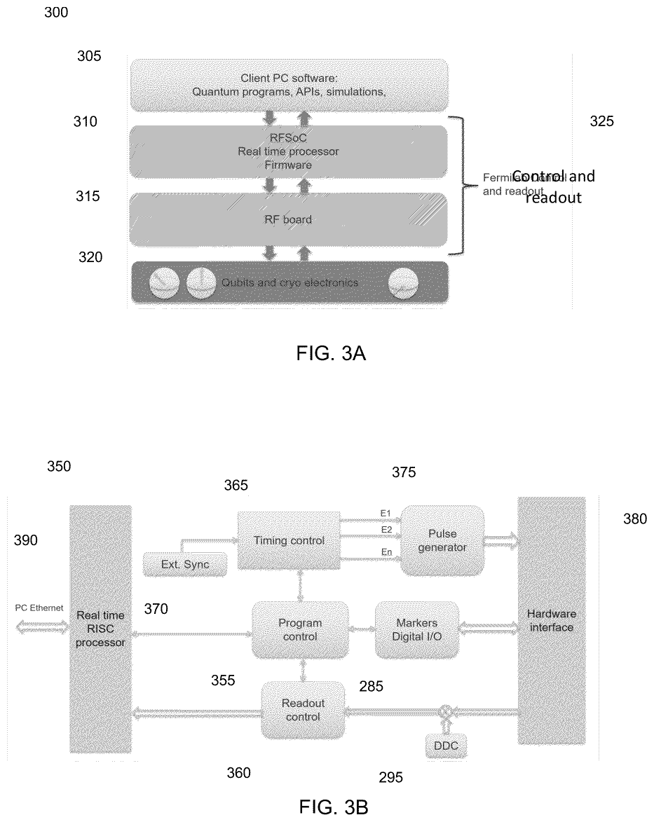

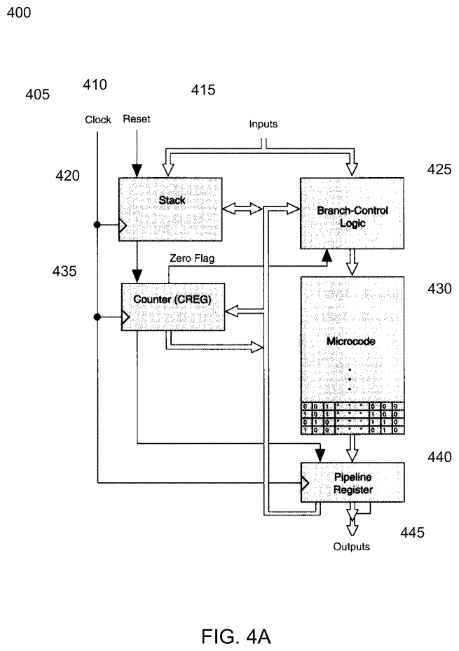

The (readout and control) FRC architecture disclosed herein and illustrated as a block diagram 300 in FIG. 3A, supports FPGA-level optimal filtering, state discrimination and feedback for qubit control. The FRC architecture also supports a clock-synchronized state machine for time-critical quantum algorithms such as gate optimization. The FRC architecture is flexible enough to optimize qubit systems as they scale in size and complexity.

The disclosed FRC comprises multi-input multi-output high performance electronics designed for quantum information science and detectors. The electronics can be used as a flexible instrument to control and characterize qubits and detectors or it can be used as a module in a multi-module architecture for a large detector instrument or quantum computer.

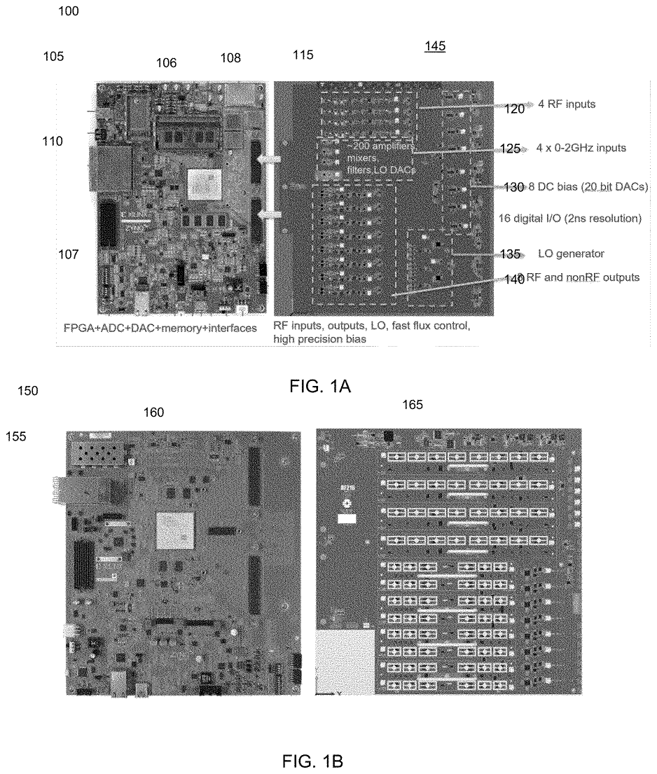

In certain embodiments the readout and control (FRC) system 100 can comprise an evaluation board 105 such as an Avnet ZCU111, containing an FPGA 110, such as an RFSOC XCZU28DR FPGA, an ADC 106, a DAC 107, a memory, and an interface, along with a custom designed RF and bias board 115 as illustrated in FIG. 1A. The RF board 115 plugs into the evaluation board 105 by means of the two RFMC high density connectors 108 making it one set. It should be appreciated that there is no limit to the number of boards that can be stacked to build a larger system as necessary for certain applications.

The bias board 115 can comprise RF inputs 120, and a set of 0-2 GHz inputs 125. The bias board further includes a set of DC bias (20 bit DACs) 130. In certain embodiments, there can be 8 such DC bias′, but other configurations with more of fewer are also possible. An LO generator 135 is provided, along with a set of RF and Non-RF outputs 140.

All the boards can be time/phase synchronized to a reference frequency, such as a 100 MHz reference, provided by an external clock source 145. In certain embodiments the clock source can comprise a rubidium clock source, but other sources are also possible.

FIG. 1B illustrates another embodiment of the FRC system 150 which can comprise an evaluation board 155, containing an FPGA 160, along with a custom designed RF and bias board 165. The RF board 165 plugs into the evaluation board 155. It should be appreciated that there is no limit to the number of boards that can be stacked to build a larger system. In this embodiment, the number of DAC outputs can be up to 16. The maximum speed at the DAC outputs is 10 GHz. The number of ADCs is now up to 16. The maximum ADC analog bandwidth is 9 GHz. In addition, the RF mixers are removed, both in the DAC outputs and the ADC inputs.

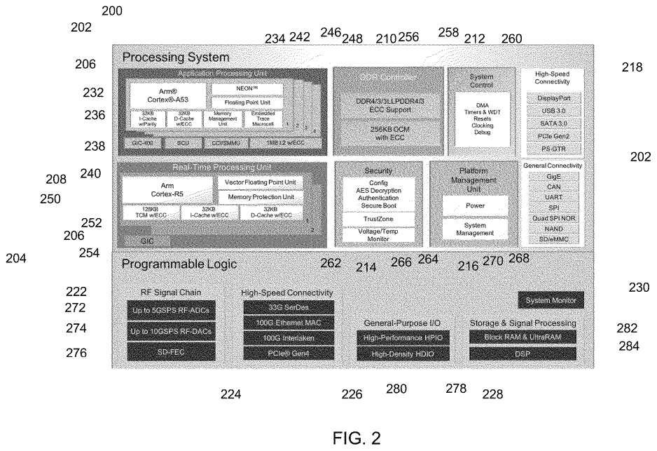

The FRC system 100 can take advantage of the highly integrated radio frequency RFSOC FPGA. FIG. 2 illustrates a block diagram of the RFSoC 200 associated with the FPGA. The RFSOC can generally include a processing system 202 and a programmable logic 204.

The processing system 202 can comprise an application processing unit 206, real-time processing unit 208, DDR control 210, system control 212, security module 214, platform management unit 216, high speed connectivity module 218, and general connectivity module 220 as further detailed herein.

The programmable logic 204 can include an RF signal chain 222, high-speed connectivity unit 224, general purpose I/O 226, storage, and signal processing module 228, and system monitor 230.

As illustrated, the application processing unit 206 can include a processor 232, floating point unit 234, I-cache 236, D-Cache 238, memory management unit 240, and embedded trace microcell 242. In certain embodiments, multiple application processing units can be provided.

The real-time processing unit 208, can comprise a processor 244, vector floating point unit 246, memory protection unit 248, tightly coupled memory 250, I-cache 252, and D-cache 254. In certain embodiments, multiple real-time processing units can be provided.

The DDR Controller 210 can generally comprise a RAM 256, and on chip memory 258. The system control 212 can further comprise DMA timers 260.

The security module 214 can further comprise a configuration module 262, a trust zone module 264, and a voltage/temperature monitor 266. The platform management unit 216 further comprises a power module 268 and system management module 270.

The programmable logic 204 can further include RF signal chain 222, which includes RF ADCs 272, RF DACs 274, and soft decision forward error connection 276. The general purpose I/O 226 can include a high-performance I/O 278 and high-density I/O 280. The storage and signal processing module 228 comprises RAM 282 and digital signal processor 284.

The RFSOC 200 can have, for example eight 6.5 Gs/s digital to analog converters (DAC) and eight 4 Gs/s analog to digital converters (ADC). Both the DAC and ADC blocks include configurable I-Q digital up/down conversion, an integrated numerically controlled oscillator (NCO), a gain matrix, and digital filters with interpolation/decimation. These constitute powerful blocks for digital signal processing. They can be integrated to operate with the logic trough standard AXI interfaces and avoid the use of high power drivers needed with external devices requiring parallel LVDS or JDEM interfaces. The RFSOC can further integrate processors, for example, two 4-core ARM Cortex A53 and a Dual ARM Cortex-R5, DDR 4 memory management, and modern interfaces such as G-Ethernet, USB 3.0, PCI, SPI, or the like.

The FRC architecture 300 takes full advantage of the RFSOC 200 functionality and complexity and develops a full RF, high speed and precision instrument for quantum computing and detectors. As illustrated in FIG. 3A, the architecture 300, includes client PC software, quantum programs, AIPs, and simulators in block 305 in operable connection with the RFSOC real time processor firmware 310. In turn the RFSOC real time processor firmware 310 is operably connected to an RF board 315, which can further be connected to the qubits and associated cryo electronics illustrated as block 320. The control and readout system 325 interfaces with these block as further detailed herein.

FIG. 3B illustrates FRC firmware 350. A program control 355 is operably connected to a readout control 360 and timing control 365. The timing control 365 can include an external sync 370. The timing control 365 is used to control timing of the pulse generator 375, which is further connected to the hardware interface 380.

The hardware interface 380 is connected to markers 285, which is further operably connected to the program control 355. The program control is configured to provide input to and receive output from the real time RISC processor 390. The readout control 360, can also receive input from the hardware interface 380 via the DDC 395. The readout control 360 can further provide input to the real time processor 390.

The FRC extends the 8 DAC outputs to either RF or DC coupled amplification and filtering. Each of the DAC outputs can be connected to a software defined switch that allows the user to choose between an RF output or a DC coupled output.

The RF output path first converts the DAC differential signal to single end using a 30 MHz-3 GHz balun. The signal can be low pass filtered, for example, at 1800 MHz, before being input to a Marki mixer. An input power of −5 to −10 dBm at the mixer optimizes the mixer performance and minimizes undesired mixing products. The output of the mixer (typically 13 dBm) is amplified and attenuated by two step attenuators. The step attenuators introduce a minimum insertion loss and total a maximum attenuation of up to 60 dB. This can proceed in 0.25 dB steps. Henceforth, the RF output power dynamic range is 4 to −56 dBm. Although the mixer MM1-0212HSM is configured to operate between 2 -12 GHz, the amplifying chain can be optimized to have the highest performance in 3-8 GHz.

Alternatively, the DAC output can be (statically) switched to a DC coupled amplifier LMH 5401 set to a gain of Av/v of 5 and up to 2 GHz of bandwidth. The main purpose of the DC coupled output is to control fast unmodulated signals such as fast flux for fluxonium qubits. The output power is directly controlled by the DAC. The pSEMI PE42020 switches can be single pole double throw (SPDT) and allow each of the DAC outputs to be individually configured for RF or DC coupled output.

The FRC electronics can provide eight 20-bit DAC outputs for biasing purpose. The bias maximum output voltage can be +/−10 volts with 1 ppm resolution, 1 ppm INL, 7.8 nV/ at 4 Hz. The 20-bit DACs are important for the biasing and DC control of flux in fluxonium qubits or charge in CPB qubits.

The digital I/O are bidirectional markers to trigger and synchronize to external instrumentation and processes. The digital I/O are software configurable and TTL level. When configured as outputs they can drive up to a 50 ohm load.

The FRC electronics can have one or more analog inputs matching the high sampling rate ADCs in the FRSOC FPGA. In certain embodiments, four of the input channels are designed for RF signals, the other four are DC coupled with an analog bandwidth of 1.5 GHz. The four RF input are designed to amplify low noise RF signals, typically, the output from a dilution refrigerator or ADR cryostat. The noise temperature of the FRC RF channel is govern by the noise figure of the first amplifier in the chain, which can be 1.4 dB. This noise figure is equivalent to a noise temperature of 110K (using 290K as ambient reference). The input signal is amplified by high gain, high P1 dB compression amplifiers and attenuated by a step attenuator with a maximum of 30 db in 0.25 dB steps. The RF input chain is mixed down using the same Marki mixer used for upconversion. The LO for mixing up and down are generated on board by a low jitter frequency synthesizer. The IF chain after the mixer has been optimized to provide a −1 dbFS at the ADC input when the mixer input power is −5 dBm. That means that the RF input dynamic range for the channel is −55 to −85 dBm. As opposed to the outputs, which can be software programmed to be used as RF or DC coupled, the inputs are not configurable. Besides the four RF inputs described above there are four DC coupled inputs with a maximum bandwidth of 1.5 GHz. These inputs can be used for detectors that are not in the RF domain or as oscilloscope or spectrum analyzer inputs.

The LO for the exemplary 12 RF mixers, 8 up converters and 4 down converters is generated by an analog device such as an ADF4372 PLL, and fractional frequency synthesizer.

To obtain the optimum required LO power at the Marki mixer the output of the frequency synthesizer is amplified and split using low noise amplifiers and power splitters. The FRC electronics can be self-contained. It generates all high precision references and power voltages. Altogether the system can include more than 200 amplifiers, mixers, filters, LO generators, switches, and drivers. All RF and DC coupled outputs/inputs are accessible via SMA connectors at the 1 U high front panel of the box.

The FRC electronic hardware illustrated in FIG. 2 and block diagram illustrated in FIG. 3A and FIG. 3B can be used for quantum computing and qubit characterization and also for detectors, in particular superconducting detectors such as MKIDs (Microwave Kinetic Inductance Detectors), TES (Transition Edge Sensors) connected to RF microchips for high density frequency multiplexing. Since the analog inputs have up to 2GHz of bandwidth (each), the number of detectors per channel depends on the channel bandwidth and separation. In certain exemplary applications 1000 MKID channels separated by 2 MHz are contemplated. The FRC electronics can fit 8000 of those channels. MKID and TES coupled to microwave resonators require an excitation tone at the resonance frequency of the pixel. The DACs are used to provide those up to 8000 resonance tones.

As opposed to MKIDs and TES detectors that can be treated as classical elements of physics, qubits are macroscopic quantum machines ruled by quantum physics. Thus, in certain embodiments, interfacing to qubits, in particular superconducting RF qubits with the purpose of controlling them and reading them without interfering with the qubit dynamics is required.

The high output bandwidth of the control outputs (close to 4 GHz) allows a qubit architecture where controls can also be multiplexed in accordance with the disclosed embodiments. It should be appreciated that, in certain embodiments up to 20 qubits with 100 MHz bandwidth and 200 MHz separation can be control by the same line, increasing the number of qubits to 100+ per board and several thousand in a modest system with few 10's of boards.

The FRC architecture disclosed herein is configured to optimize the following aspects:
1) Flexible quantum programming at a client computer (PC) using a high level language such as Python or C++. The language uses a definition file or script that defines the hardware architecture, such as inputs and outputs objects and their properties. A compiler interprets the high level code and generates a machine language that is run on the FPGA.
2) Time critical functions are time and phase synchronized to keep all qubits on the same reference frame. The synchronization is maintained when multiple FRC modules are grouped into a system.
3) Signals are clean of undesired spurs and harmonics. RF controls use digital IQ mixers and fast I-Q digital up converters (DDC) to avoid in-band spurs and avoid tedious calibration processes (such as due to analog I-Q mixers) that also drift over time.
4) The readout process is optimized in latency to 100 ns roundtrip given by the DAC and ADC blocks and internal AXI interfaces.
5) Control pulses are generated by a user defined library of templates. e.g., Gaussian, square, triangular or any AWG envelope can be stored in a library that accepts several million samples per waveform in internal memory of giga samples in DDR4 memory.

A quantum program can be written in high level language. An exemplary program written in Python can use a configuration file and a script. The configuration file describes the system architecture and initializes static values of the hardware. The configuration file can also configure the pulse library to be used by the pulse generator. The configuration file can also assign values to the RF hardware and initialize unused functions to their default values.

The main script utilizes keywords for the compiler to implement quantum programming functions. The use of keywords allows, for instance, the ability to run python in an interactive way. The compiler can ignore any script cells that it does not recognize. The compiler converts a high level piece of code into a time critical list of machine language instructions and parameters for the logic to execute. The FPGA logic program and timing control work as a microsequencer.

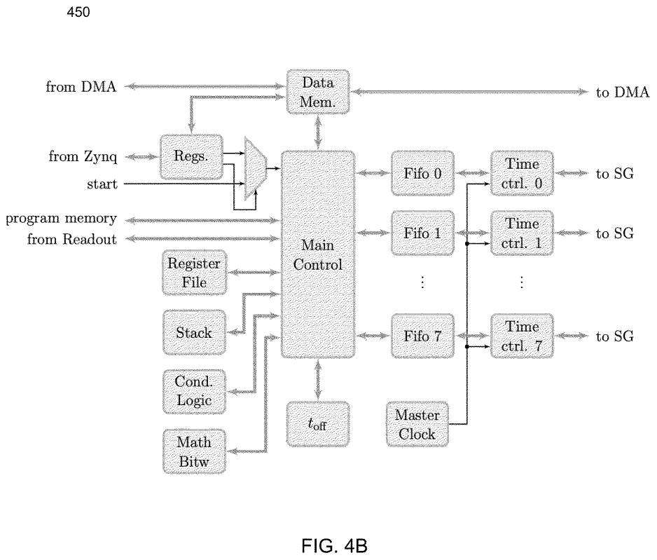

Aspects of a microsequencer 400 are illustrated in FIG. 4A. The microsequencer 400 includes a clock 405 and reset 410. Inputs 415 are provided to the stack 420 and branch control logic 425, further operably connected to microcode 430. The microsequencer 400 includes a counter 435, or program counter (PC), a loop counter (LC) configured in connection with the stack 420 and the program list. The microcode 430 is operably connected to the pipeline register 440, which receives input from the counter 435 and clock 405, and provides outputs 445.

The microsequencer 400 structure is extremely flexible and avoids the need to implement complicated state machines for quantum programming elementary functions and higher level state machines run by logic or under software control. For example, FIG. 4B illustrates another embodiment of a microsequencer 450.

The microsequencer 400 can store instructions and parameters such as timing, amplitude, and frequency information. Pulse shapes, readout timing, delays and all other information needed to keep the quantum program running phased and synchronized to the master clock can also be provided. The microsequencer allows multiple control lines to work in parallel synchronously. The markers and readout are also synchronized to the same clock. The LC thus facilitates running experiments multiple times without requiring PC software intervention.

Multiple nested loops can be allowed with help from the stack. For instance, if the program has two nested FOR loops, when the microsequencer finds the inner loop, it pushes the essential information onto the stack and runs the inner loop. When the execution of the inner loop is finished, it recovers the outer loop information popping it from the stack. The multiway single clock allows for fast program bifurcation keeping the latency low. In order to keep the critical part of a quantum program phase synchronized, the microsequencer looks ahead into the instruction set and keeps the pulse generator and the readout busy and synchronized to avoid time/phase gaps.

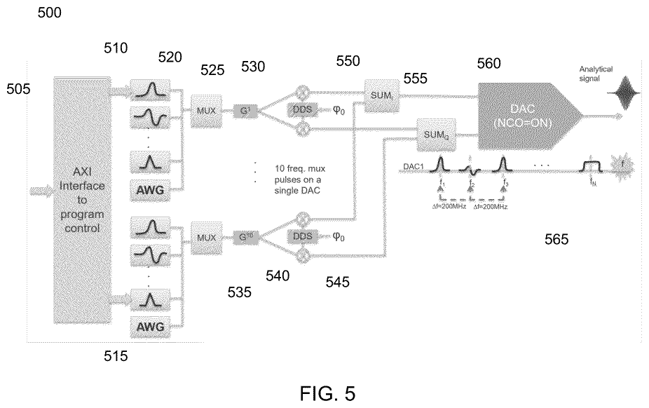

FIG. 5 illustrates a system 500 an RF pulse or arbitrary waveform generator (AWG). The Pulse Generator 500 is a key part of the logic. In short, it generates the correct pulse shape at the right time. FIG. 5 shows one of the exemplary 8 output channels that can be defined as the RF pulse or AWG. The system 500 has an interface 505 operably connected to a first set of wave form generators 510 and the second set of wave form generators 515. The output from the wave form generator 510 is provided to a mixer 520 and splitter 525. The split signal is subject to a direct digital synthesizer 530. The output from the wave form generator 515 is provided to a mixer 535 and splitter 540. The split signal is subject to a direct digital synthesizer 545. The one of the split signals from each of DDS 530 and DDS 545 is provided to a first summing block 550. The other of the split signals from each of DDS 530 and DDS 545 is provided to a second summing block 555. Output from each of summing block 550 and summing block 555 is provided to DAC 560.

The pulse generator can have access to a library of pulses. The system can be used to create pulse templates. The templates can have an arbitrary waveform, including the typical Gaussian, sync, triangular, etc. waveforms. A pulse duration is defined by its number of samples and clock rate. If two similar pulses (e.g., Gaussian) are needed with different length, both pulses need to be stored.

The pulses after split in I and Q and application of a defined gain, are used as envelopes to an IF carrier. The IF is generated by the fast DDS (e.g., DDS 530 or DDS 545), made possible by the FRC firmware 350 illustrated in FIG. 3B. A fast DDS is a composite structure that can generate a sine/cosine waveform at a frequency many times faster than the FPGA clock. The fast DDS is designed to be able to implement IF carriers of up to 4 GHZ, which is the maximum analog bandwidth of the DAC. The fast DDS is critical for implementing an RF domain free of spurs from mixing products and non-linearities. Pulse amplitudes and IF (RF) frequencies are assigned during quantum programming. The same template can be used in a program using different pulse amplitudes and IF (RF) frequencies. Changing the IF carrier frequency is done by instructions in the programming flow. The pulse generator can change from IF1 to IF2 in one clock cycle keeping the phase synchronized to the master phase/clock as illustrated in FIG. 5.

Another feature of the pulse generator is the ability to generate and output signal as the sum of numerous (e.g., up to 10) modulated envelopes each one with its own user defined IF. An example is shown in the inset 565 of FIG. 5, where pulses are frequency multiplexed separated by 200 MHz. The pulses can be overlapping in time or time multiplexed. The IFi amplitudes Ai and starting time Ti are user defined by the quantum program.

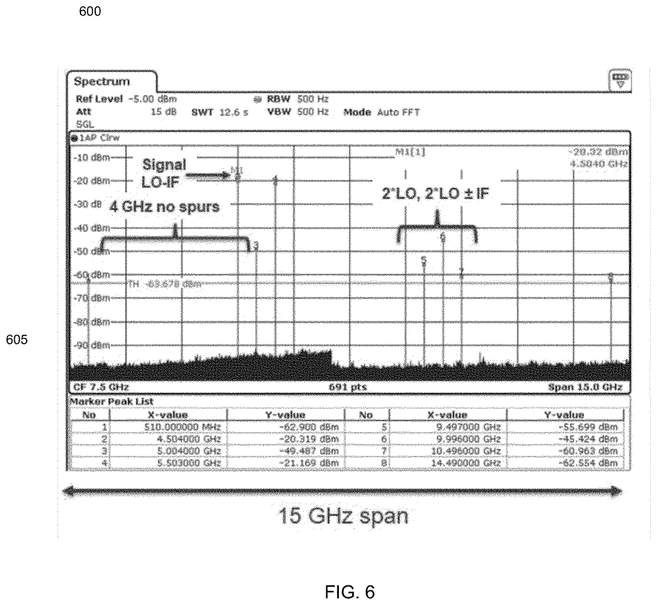

FIG. 6 shows an oscilloscope interface 600 and associated trace 605 showing 4 portions of IF signals with different frequencies, and amplitudes, using sine or square envelopes and phase synchronized to the origin of the plot. There is not a transient when the IF frequency or envelope changes.

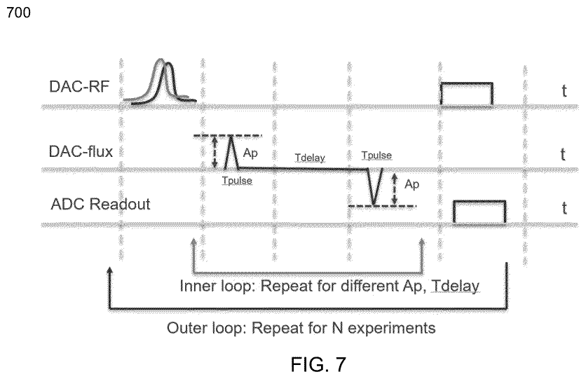

Exemplary aspects of the disclosed embodiments including a timing diagram 700 for heavy-fluxonium are illustrated in FIG. 7. Specifically, FIG. 7 provides a timing diagram 700 for a typical randomized benchmarking test. The qubit is first cooled down to a temperature of 200K by simultaneously driving both |g0>→|h0> and |h0→|e1> transitions. The spontaneous photon decay |e1>→|e0> provides a directional transition and completes the reset. This action requires from one channel of the pulse generator the simultaneous application of two different RF frequencies modulated by Gaussian envelopes during 5 to reset 97% of the population. After reset, the qubit is controlled by net zero flux pulses which consist in a triangular flux pulse with energy content in the DC-500 MHz range followed by a controlled idling time and another triangular pulse with opposite sign. It is important that the area of the opposite triangular pulses be the same and to have fine time resolution of the idling time duration. The sequence allows Y, Y/2 and Z rotations for universal control.

Fidelity measurements can be performed through randomized benchmarking (RB) and interleaved RB (IRB). RB provides a measure of the average [U+FB01]delity of single-qubit Cli[U+FB00]ord gates and is performed by applying sequences containing varying number of Cli[U+FB00]ord gates on the state |e> as illustrated in FIG. 8. This requires the Pulse Generator to be able to cycle through a sequence of bidirectional flux pulses of different amplitudes and idling times.

FIG. 8 illustrates a chart 805 of readout pulse frequency, a chart 810 or normalized DAC gain, a chart 815, illustrating counts as a function of I, a chart 820 of qubit pulse frequency, a chart 825 showing pulses over time, and chart 830 showing sequency length.

The sequence includes all the required waveforms to achieve RB and IRB fidelity measurements. The process can be repeated many times (N) to reduce statistical uncertainties. The FRC electronics disclosed herein, are able of compiling the N runs of the entire run and creating a microsequencer list. The microsequencer 400, can handle long flexible quantum programs involving all the resources available on the electronics. All generated waveforms and readouts are phase synchronized to a 64-bit master clock with a maximum time duration of up to half a million days. The master clock is restarted when a new quantum program is launched by the PC. The length of a quantum program in memory resources, can be limited by the size of the RFSOC internal memory (BRAM).

Microsequencer programs are made by compiling a quantum program to machine language, henceforth memory efficient. The previous fluxonium process only occupies a few hundred bytes. The RFSOC can have almost 10 MB of BRAM in exemplary embodiments. The FRC electronics uses the BRAM for the pulse generator library, for the readout and for the microsequencer list. Memory can be allocated to the microsequencer exceeding by far the longest quantum program use case. The microsequencer memory can be easily extended using the FPGA processor's cache or external DDR4 if needed.

The RF section of the FRC electronics are configured to avoid the generation of undesired spurs in the working band of interest and to avoid lengthy calibrations that drift over time, during the course of a process. One of the main reasons why quantum and detector RF electronics require calibration is due to unequal complex gains in I-Q mixers. I-Q mixers are in fact two mixers connected by a 90° phase rotation. The amplitude and gain of the I and Q mixers over a large bandwidth (e.g., 4-8 GHz) typically differ by ±half a dB and a few degrees. Calibration require a frequency dependent amplitude/phase 2×2 matrix. The equations to calculate the matrix values are more involved for multiple tones. For instance, sideband rejection of 1000 tones for MKIDs achieve at best 30 dB and requires frequent calibrations due to temperature drifts. The FRC electronics uses high frequency digital DDS and I-Q mixers. There is no gain error other than a very small roundoff bit that introduces less than −100 dBm error. There is no need to recalibration either. The RF mixer is a non I-Q DBM (Double Balanced Mixer). DBM generate the two sidebands LO±IF. The mixer also has some direct IF and LO leakage into the RF output. The mixer nonlinearity also generate nLO±mIF outputs.

The fast DDS allows an IF pulse anywhere in the near DC to 4 GHz spectrum. If the 0.5-4 GHz IF spectrum is multiplied by an 8 GHz LO, the two sidebands are at 4-7.5 GHz and 8.5-12 GHz. The IF and LO feedthrough, and nLO±mIF products do not fall inside the 4-7.5 GHz band and are easily filtered. We have left a 500 MHz of room between the LO and the LSB of interest to allow for 40 dB+ of filtering.

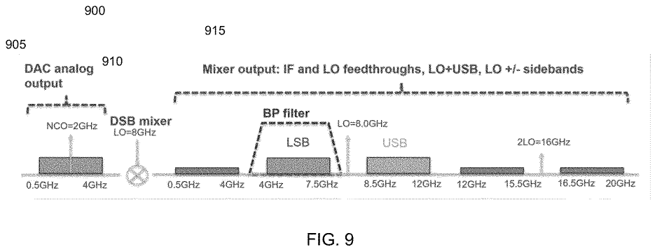

FIG. 9 illustrates a chart 900 of up conversion from IF, the DAC output, to RF. Chart 600 in FIG. 6 illustrates a typical 17 dB LO which is attenuated 66 dB and shows at −49 dB. As illustrated a DAC analog output 905 is provided to a DSB mixer 910. The mixer output 915 can include the IF and LO feedthroughs, LO+USB, and LO +/−sidebands. The minicircuits LFCW-6000+ adds another 43 dB of attenuation at 8 GHz making the LO below −93 dB. The advantage of the fast DDS is that a pulse can be placed anywhere in the 4-7.5 GHz band keeping the analog mixer 910 LO fixed at 8 GHz. That maximizes the IF, LO feedthroughs and nLO±mIF product filtering. The noise floor in the 4-7.5 GHz band is −135 dBc/Hz.

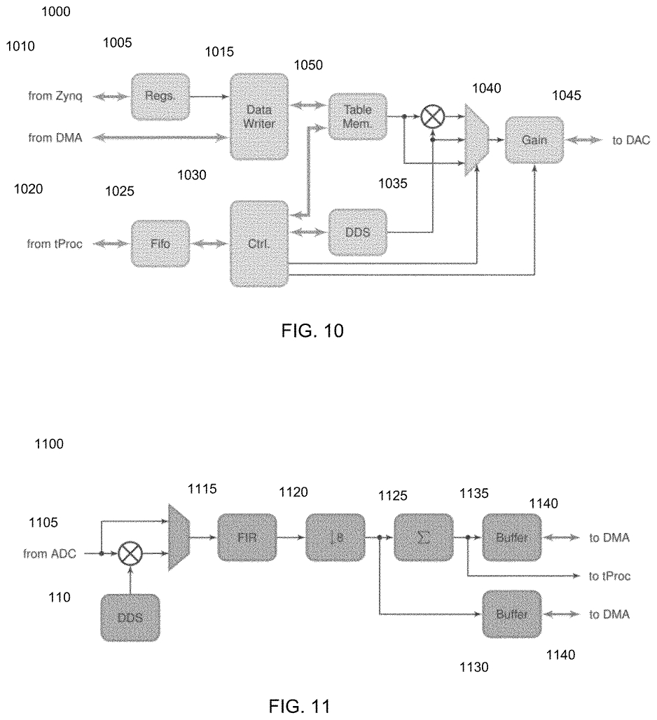

FIG. 10 illustrates an exemplary block diagram of a digital to analog converter (DAC) output 1000 in accordance with the disclosed embodiments. The DAC output 1000 includes a register 1005, configured to receive input 1010. The register 1005 provides data to the data writer 1015, which has direct memory access 1020. The first in first out module 1025 provides input to the control 1030. The control 1030 and data writer 1015. The control further provides input to the direct digital synthesis module 1035. The waveform from the DDS 1035 and the table memory 1050 input are then provided to gain 1040, along with a control signal from the control 1030, where the gain is operably connected to a DAC 1045.

FIG. 11 illustrates a block diagram of an RF input block 1100 in accordance with the disclosed embodiments. Input from an ADC 1105 is combined with a DDS 1110 output and provided to an FIR digital filter 1115. The digital filter output is then down converted at block 1120 and split to provide input to counter 1125 and buffer 1130 respective. The counter 1125 output is provided to buffer 1135. Buffer 1135 and buffer 1130 are operably connected to the DMA 1140.

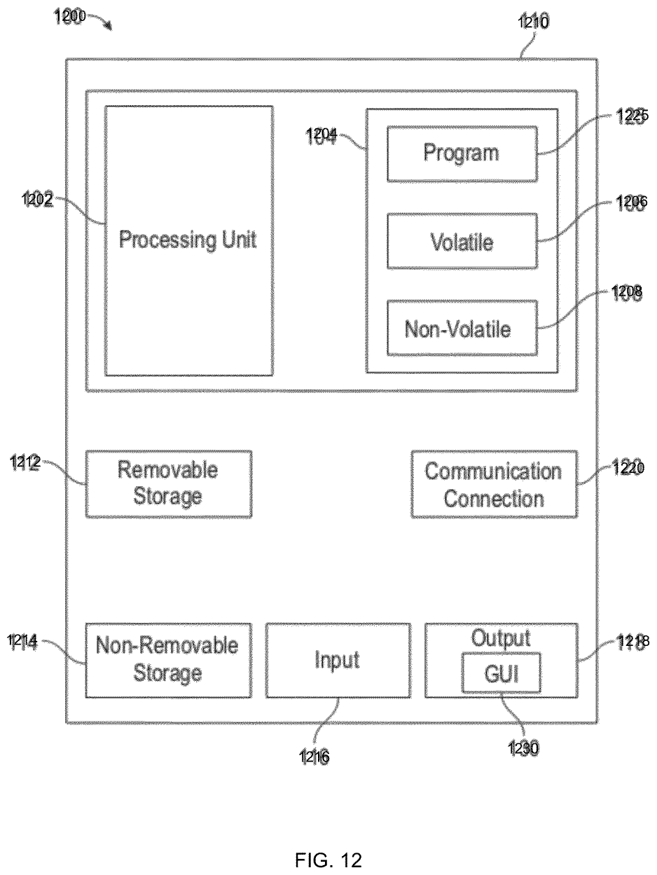

FIGS. 12-14 are provided as exemplary diagrams of data-processing environments in which embodiments can be implemented. It should be appreciated that FIGS. 12-14 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments. It should be further appreciated that these computer environments can be representative of classical computing system or quantum computing systems.

A block diagram of a computer system 1200 that executes programming for implementing parts of the methods and systems disclosed herein is shown in FIG. 12. A computing device in the form of a computer 1210 configured to interface with sensors, peripheral devices, and other elements disclosed herein may include one or more processing units 1202, memory 1204, removable storage 1212, and non-removable storage 1214. Memory 1204 may include volatile memory 1206 and non-volatile memory 1208. Computer 1210 may include or have access to a computing environment that includes a variety of transitory and non-transitory computer-readable media such as volatile memory 1206 and non-volatile memory 1208, removable storage 1212 and non-removable storage 1214. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

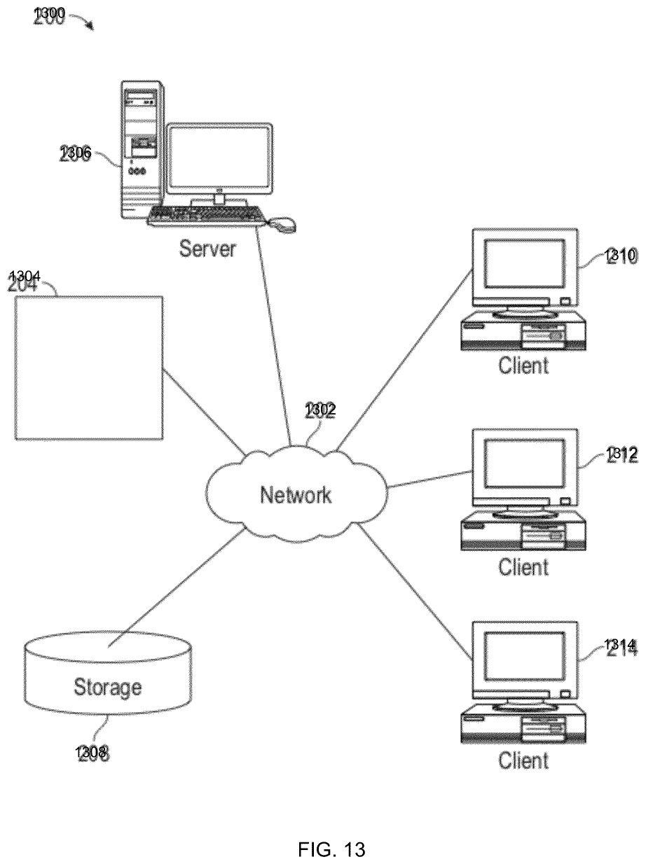

Computer 1210 may include or have access to a computing environment that includes input 1216, output 1218, and a communication connection 1220. The computer may operate in a networked environment using a communication connection 1220 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 13 below.

Output 1218 is most commonly provided as a computer monitor, but may include any output device. Output 1218 and/or input 1216 may include a data collection apparatus associated with computer system 1200. In addition, input 1216, which commonly includes a computer keyboard and/or pointing device such as a computer mouse, computer track pad, or the like, allows a user to select and instruct computer system 1200. A user interface can be provided using output 1218 and input 1216. Output 1218 may function as a display for displaying data and information for a user, and for interactively displaying a graphical user interface (GUI) 1230.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 1216 such as, for example, a pointing device such as a mouse and/or with a keyboard. A particular item can function in the same manner to the user in all applications because the GUI provides standard software routines (e.g., module 1225) to handle these elements and report the user's actions. The GUI can further be used to display the electronic service image frames as discussed below.

Computer-readable instructions, for example, program module or node 1225, which can be representative of other modules or nodes described herein, are stored on a computer-readable medium and are executable by the processing unit 1202 of computer 1210. Program module or node 1225 may include a computer application. A hard drive, CD-ROM, RAM, Flash Memory, and a USB drive are just some examples of articles including a computer-readable medium.

FIG. 13 depicts a graphical representation of a network of data-processing systems 1300 in which aspects of the present invention may be implemented. Network data-processing system 1300 is a network of computers or other such devices such as mobile phones, smartphones, sensors, detection devices, controllers, and the like in which embodiments of the present invention may be implemented. Note that the system 1300 can be implemented in the context of a software module such as program module 1225. The system 1300 includes a network 1302 in communication with one or more clients 1310, 1312, and 1314. Network 1302 may also be in communication with one or more devices 1304, servers 1306, and storage 1308. Network 1302 is a medium that can be used to provide communications links between various devices and computers connected together within a networked data processing system such as computer system 1200. Network 1302 may include connections such as wired communication links, wireless communication links of various types, fiber optic cables, quantum, or quantum encryption, or quantum teleportation networks, etc. Network 1302 can communicate with one or more servers 1306, one or more external devices such as a controller, actuator, particle accelerator, associated electron beam accelerator, or other such device 1304, and a memory storage unit such as, for example, memory or database 1308. It should be understood that device 1304 may be embodied as a detector device, FPGA, microcontroller, controller, receiver, transceiver, or other such device.

In the depicted example, device 1304, server 1306, and clients 1310, 1312, and 1314 connect to network 1302 along with storage unit 1308. Clients 1310, 1312, and 1314 may be, for example, personal computers or network computers, handheld devices, mobile devices, tablet devices, smartphones, personal digital assistants, microcontrollers, recording devices, MFDs, etc. Computer system 1200 depicted in FIG. 12 can be, for example, a client such as client 1310 and/or 1312.

Computer system 1200 can also be implemented as a server such as server 1306, depending upon design considerations. In the depicted example, server 1306 provides data such as boot files, operating system images, applications, and application updates to clients 1310, 1312, and/or 1314. Clients 1310, 1312, and 1314 and external device 1304 are clients to server 1306 in this example. Network data-processing system 1300 may include additional servers, clients, and other devices not shown. Specifically, clients may connect to any member of a network of servers, which provide equivalent content.

In the depicted example, network data-processing system 1300 is the Internet with network 1302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 1300 may also be implemented as a number of different types of networks such as, for example, an intranet, a local area network (LAN), or a wide area network (WAN). FIGS. 12 and 13 are intended as examples and not as architectural limitations for different embodiments of the present invention.

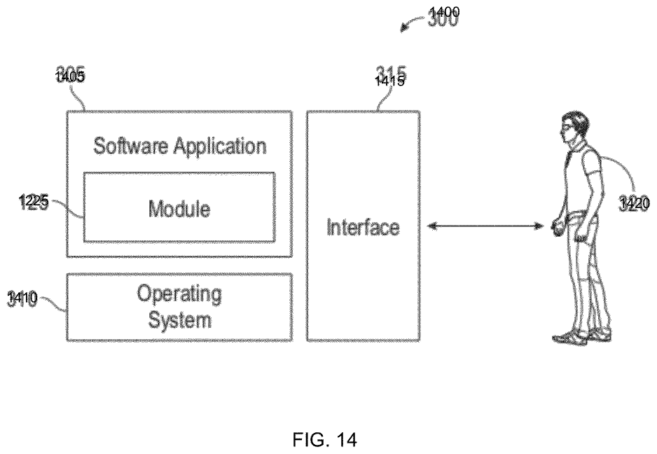

FIG. 14 illustrates a software system 1400, which may be employed for directing the operation of the data-processing systems such as computer system 1400 depicted in FIG. 14. Software application 1405, may be stored in memory 1404, on removable storage 1212, or on non-removable storage 1214 shown in FIG. 12, and generally includes and/or is associated with a kernel or operating system 1410 and a shell or interface 1415. One or more application programs, such as module(s) or node(s) 1225, may be “loaded” (i.e., transferred from removable storage 1212 into the memory 1204) for execution by the data-processing system 1400. The data-processing system 1400 can receive user commands and data through user interface 1415, which can include input 1216 and output 1218, accessible by a user 1420. These inputs may then be acted upon by the computer system 1200 in accordance with instructions from operating system 1410 and/or software application 1405 and any software module(s) 1225 thereof.

Generally, program modules (e.g., module 1225) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 1415 (e.g., a graphical user interface 1230) can serve to display results, whereupon a user 1420 may supply additional inputs or terminate a particular session. In some embodiments, operating system 1410 and GUI 1230 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 1410 and interface 1415. The software application 1405 can include, for example, module(s) 1225, which can include instructions for carrying out steps or logical operations such as those shown and described herein.

The description is presented with respect to embodiments of the present invention, which can be embodied in the context of, or require the use of a data-processing system such as computer system 1200, in conjunction with program module 1225, and data-processing system 1400 and network 1302 depicted in FIGS. 12-14. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation. In other embodiments, manual control of various aspects may be achievable while closely monitoring readbacks.

The embodiments disclosed herein include an integrated RF/FPGA-based qubit control system that integrates analog bandwidth DACs/ADCs with a System on Chip containing several different ARM processors and a large FPGA. RF channels are controlled by a single module; there is a high channel density, and the channels can be re-programmed into any feedback configuration. The FRC architecture generally supports FPGA-level optimal filtering, state discrimination and feedback for qubit control. The FRC architecture disclosed herein, supports a clock-synchronized state machine for time-critical quantum algorithms such as gate optimization. The FRC architecture is flexible enough to optimize qubit systems as they scale in size and complexity.

Based on the foregoing, it can be appreciated that a number of embodiments are disclosed herein. In an embodiment, a system for readout and control of quantum devices, comprises a first board comprising a field programmable gate array and a radio frequency and bias board.

In an embodiment, the system for readout and control of quantum devices further comprises an analog-to-digital converter configured on the first board and a digital to analog converter configured on the first board. In an embodiment, the system for readout and control of quantum devices further comprises a memory configured on the first board. In an embodiment, the field programmable gate array further comprises a radio frequency system on chip. In an embodiment, the radio frequency system on chip further comprises a pulse generator. In an embodiment, the system for readout and control of quantum devices further comprises the radio frequency system on chip further comprises a program control, a timing control, and a readout control.

In an embodiment, the system for readout and control of quantum devices further comprises a processing system, the processing system further comprising: an application processing unit and a real time processing unit. In an embodiment, the processing system further comprises a DDR controller. In an embodiment, the processing system further comprises a security module and a platform management unit. In an embodiment, the system for readout and control of quantum devices further comprises a system control.

In an embodiment, the system for readout and control of quantum devices further comprises a microsequencer. In an embodiment, the microsequencer is configured for storing instructions and storing parameters comprising: timing, amplitude, and frequency information.

In another embodiment, a system for readout and control of quantum devices, comprises a first board comprising a field programmable gate array, an analog-to-digital converter, and a digital to analog converter, wherein the first board is time and phase synchronized to a reference frequency and a radio frequency and bias board connected to the first board with at least one high density connector, wherein the radio frequency and bias board is time and phase synchronized to the reference frequency.

In an embodiment, the system for readout and control of quantum devices further comprises an external clock source for generating the reference frequency. In an embodiment, the external clock source comprises a rubidium clock source.

In an embodiment, the system for readout and control of quantum devices further comprises a program control, a timing control, and a readout control.

In an embodiment, the system for readout and control of quantum devices further comprises a processing system, the processing system further comprising: an application processing unit and a real time processing unit.

In an embodiment, the system for readout and control of quantum devices further comprises a DDR controller, a security module, a platform management unit, and a system control.

In an embodiment, the system for readout and control of quantum devices further comprises a microsequencer, wherein the microsequencer is configured for storing instructions and storing parameters comprising: timing, amplitude, and frequency information.

In another embodiment, a qubit control system comprises at least one analog bandwidth DAC, at least one analog bandwidth ACS, and a system on chip board comprising: a plurality of ARM processors and a field programmable gate array, and a plurality of RF channels wherein all of the plurality of RF channels are controlled by a single control module.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system for readout and control of quantum devices, comprising:
a first board comprising a field programmable gate array; and
a radio frequency and bias board.

2. The system for readout and control of quantum devices of claim 1 further comprising:
an analog-to-digital converter configured on the first board; and
a digital to analog converter configured on the first board.

3. The system for readout and control of quantum devices of claim 1 further comprising:
a memory configured on the first board.

4. The system for readout and control of quantum devices of claim 1 wherein the field programmable gate array further comprises:
a radio frequency system on chip.

5. The system for readout and control of quantum devices of claim 4 wherein the radio frequency system on chip further comprises:
a pulse generator.

6. The system for readout and control of quantum devices of claim 5 wherein the radio frequency system on chip further comprises:
a program control;
a timing control; and
a readout control.

7. The system for readout and control of quantum devices of claim 1 further comprising:
a processing system, the processing system further comprising:
an application processing unit; and
a real time processing unit.

8. The system for readout and control of quantum devices of claim 7 wherein the processing system further comprises:
a DDR controller.

9. The system for readout and control of quantum devices of claim 7 wherein the processing system further comprises:
a security module; and
a platform management unit.

10. The system for readout and control of quantum devices of claim 7 wherein the processing system further comprises:
a system control.

11. The system for readout and control of quantum devices of claim 1 further comprising:
a microsequencer.

12. The system for readout and control of quantum devices of claim 11, wherein the microsequencer is configured for:
storing instructions; and
storing parameters comprising: timing, amplitude, and frequency information.

13. A system for readout and control of quantum devices, comprising:
a first board comprising a field programmable gate array, an analog-to-digital converter, and a digital to analog converter, wherein the first board is time and phase synchronized to a reference frequency; and
a radio frequency and bias board connected to the first board with at least one high density connector, wherein the radio frequency and bias board is time and phase synchronized to the reference frequency.

14. The system for readout and control of quantum devices of claim 13, comprising:
an external clock source for generating the reference frequency.

15. The system for readout and control of quantum devices of claim 14, wherein the external clock source comprises a rubidium clock source.

16. The system for readout and control of quantum devices of claim 13 further comprising:
a program control;
a timing control; and
a readout control.

17. The system for readout and control of quantum devices of claim 13 further comprising:
a processing system, the processing system further comprising:
an application processing unit; and
a real time processing unit.

18. The system for readout and control of quantum devices of claim 17 wherein the processing system further comprises:
a DDR controller;
a security module;
a platform management unit; and
a system control.

19. The system for readout and control of quantum devices of claim 13 further comprising:
a microsequencer, wherein the microsequencer is configured for:
storing instructions; and
storing parameters comprising: timing, amplitude, and frequency information.

20. A qubit control system comprising:
at least one analog bandwidth DAC;
at least one analog bandwidth ACS;
a system on chip board comprising:
a plurality of ARM processors; and
a field programmable gate array; and
a plurality of RF channels wherein all of the plurality of RF channels are controlled by a single control module.
